(19) United States
(12) Patent Application Publication
(10) Pub. No.: US 2026/0316506 A1
(43) Pub. Date: Oct. 15, 2026

(54) SHOCK ABSORBERS AND VEHICLE COMPRISING THE SAME

(71) Applicant: HL MANDO CORPORATION, Gyeonggi-do (KR)

(72) Inventor: Eunjoong KIM, Gyeonggi-do (KR)

(21) Appl. No.: 19/640,421

(22) Filed: Apr. 7, 2026

(30) Foreign Application Priority Data
Apr. 14, 2025 (KR) 10-2025-0048009

(51) Int. Cl. B60G 13/08

(52) U.S. Cl. CPC B60G 13/08; B60G 2202/24; B60G 2202/415

(57) ABSTRACT

The present invention relates to a shock absorber, comprising: a cylinder which includes a base shell, and a first tube and a second tube installed so as to be spaced apart inside the base shell, wherein an internal space of the first tube is divided into a compression chamber and a rebound chamber by a piston head, and the cylinder includes an intermediate chamber, which is a space between the first tube and the second tube, and a reservoir chamber, which is a space between the second tube and the base shell; a compression solenoid valve mounted on the cylinder; and a rebound solenoid valve mounted on the cylinder, wherein the compression solenoid valve and the rebound solenoid valve are arranged along a circumferential direction of the cylinder.

### TECHNICAL FIELD

The present invention relates to a shock absorber and a vehicle comprising same, and more particularly, to a variable damping force shock absorber capable of appropriately adjusting damping force characteristics

### BACKGROUND ART

As vehicles become more popular, consumers' knowledge and demands for vehicles are gradually increasing. In addition to purpose of use, convenience, and economy, functional performances such as output, quietness, ride comfort, and handling stability have also become important selection criteria for consumers purchasing vehicles.

While driving, a vehicle is constantly subjected to vibrations and shocks from the road surface through its wheels. If vibrations or shocks transmitted through the wheels are directly transferred to the vehicle body and steering wheel, ride comfort and driving stability are significantly deteriorated. Therefore, a suspension system is essential for vehicles. Shock absorber, spring, and suspension arm are the main components that constitute a suspension system.

A shock absorber comprises a cylinder, a piston rod, and a piston valve. The piston valve is disposed inside the cylinder while being coupled to the piston rod, and generates a damping force

A shock absorber can improve ride comfort by absorbing vibrations caused by road irregularities when the damping force is set to a low level; conversely, when the damping force is set to a high level, vehicle body attitude changes are suppressed, improving handling stability. Accordingly, it has been common practice to select and apply shock absorbers with different damping characteristics depending on the vehicle's intended use.

Recently, variable damping force shock absorbers have been developed, which are equipped with a variable damping force valve capable of appropriately adjusting damping characteristics according to road surface conditions and driving states.

For example, a variable-damping-force shock absorber having a dual-solenoid structure, equipped with a rebound solenoid valve for adjusting the damping force during the rebound stroke and a compression solenoid valve for adjusting the damping force during the compression stroke, is being developed. The interior of the cylinder of the shock absorber is divided into a compression chamber and a rebound chamber by a piston valve, and each chamber is filled with a fluid such as oil.

During the compression stroke, the piston valve pressurizes the fluid within the compression chamber, whereby the compression chamber becomes a high-pressure region and, correspondingly, the rebound chamber becomes a low-pressure region. During the rebound stroke, the piston valve pressurizes the fluid in the rebound chamber, so the rebound chamber becomes high pressure and the compression chamber becomes relatively low pressure.

Meanwhile, a conventional variable damping force shock absorber having a dual solenoid valve structure basically requires a separate tube, a solenoid, and a flow passage connecting an outlet of a rebound flow path to an inlet of a compression flow path. However, since the compression separate tube and the rebound separate tube must be assembled along the axial direction of the shock absorber, a step height difference inevitably occurs. In addition, in the conventional technology, while maintaining the portion where a height difference occurs, the solenoid valve is disposed along the axial direction of the shock absorber, and the flow passage connecting an outlet of the rebound flow path to an inlet of the compression flow path is configured as a block. However, because of its high price, the dual-solenoid valve is mainly considered for application to air suspension, but with an air spring the shock absorber has much less axial packaging space than with a coil spring, so the dual-solenoid manifold block cannot be packaged.

### PRIOR ART DOCUMENTS

### Patent Document

(Patent Document 1) Korean Patent Publication No. 10-2023-0068294 (Published: May 17, 2023).

### SUMMARY OF THE INVENTION

### Technical Problem

An object of the present invention is to provide a shock absorber that is readily applicable to air suspension.

Another object of the present invention is to improve ease of assembly by reducing the number of parts.

Furthermore, another object of the present invention is to increase the damping force achievable compared with that of conventional shock absorbers by enabling smooth fluid flow.

However, the technical problems to be solved by the present invention are not limited to those set forth above, and other problems not expressly mentioned will be clearly understood by those of ordinary skill in the art from the following description.

### Solution to the Problem

A variable damping force shock absorber according to an embodiment of the present invention comprises: a cylinder including a base shell, in which a first tube and a second tube are installed with a spacing therebetween inside the base shell, wherein an internal space of the first tube is divided into a compression chamber and a rebound chamber by a piston head, and the cylinder further includes an intermediate chamber, defined as a space between the first tube and the second tube, and a reservoir chamber, defined as a space between the second tube and the base shell; a compression solenoid valve mounted on the cylinder; and a rebound solenoid valve mounted on the cylinder, wherein the compression solenoid valve and the rebound solenoid valve are disposed circumferentially around the cylinder.

In one aspect of the present invention, the compression solenoid valve and the rebound solenoid valve may be arranged in a horizontal direction.

For example, the compression solenoid valve and the rebound solenoid valve may be arranged on an imaginary plane perpendicular to the central axis of the cylinder.

In another aspect of the present invention, the compression solenoid valve and the rebound solenoid valve are disposed on an imaginary plane forming a predetermined angle with a central axis of the cylinder, wherein the predetermined angle may be an acute angle or an obtuse angle.

In another aspect of the present invention, the cylinder may further include a post member mounted on the outside of the cylinder and configured to fixedly support the compression solenoid valve and the rebound solenoid valve such that they are spaced apart.

Preferably, the post member may include: a first hollow fixing portion into which the compression solenoid valve is inserted and fixed; a second hollow fixing portion spaced apart from the first fixing portion and into which the rebound solenoid valve is inserted and fixed; and a connecting portion connecting the first fixing portion and the second fixing portion.

At this time, a first receiving bore, into which the compression solenoid valve is inserted and fixed, may be formed in the first fixing portion, and a second receiving bore, into which the rebound solenoid valve is inserted and fixed, may be formed in the second fixing portion.

In one aspect of the present invention, a communication hole may be formed in the connecting portion so as to directly bring the compression solenoid valve and the rebound solenoid valve into communication by interconnecting internal spaces of the first fixing portion and the second fixing portion.

Preferably, the communication hole may be provided with a reservoir passage in direct communication with the reservoir chamber.

In another aspect of the present invention, the post member may include a compression passage configured to be in direct communication with the compression chamber from one end of the first fixing portion.

At this time, the compression passage can connect one end of the first receiving bore and the compression chamber.

In another aspect of the present invention, the post member may include a rebound passage configured to be in direct communication with the intermediate chamber from one end of the second fixing portion.

At this time, the rebound passage can connect one end of the second receiving bore and the intermediate chamber.

In one aspect of the present invention, the intermediate chamber may be configured to be in fluid communication with the rebound chamber.

In another aspect of the present invention, at least one orifice is provided in an upper region of the first tube interposed between the intermediate chamber and the rebound chamber, and oil is allowed to flow between the intermediate chamber and the rebound chamber through the orifice.

In another aspect of the present invention, the compression solenoid valve may include: a compression valve housing forming an exterior of the valve; and a first check valve configured to open only during a rebound stroke and to close during a compression stroke.

In another aspect of the present invention, the rebound solenoid valve may include a rebound valve housing forming the exterior of the valve; and a second check valve configured to open only during a compression stroke and close during a rebound stroke.

In one aspect of the present invention, during a rebound stroke, oil accommodated in the rebound chamber may be configured to move from the rebound chamber to the intermediate chamber through an orifice provided in an upper region of the first tube interposed between the intermediate chamber and the rebound chamber, then pass through the rebound passage and the rebound solenoid valve, and subsequently move to the compression chamber through a first check valve of the compression solenoid valve via a communication hole provided in the connecting portion and interconnecting internal spaces of the first fixing portion and the second fixing portion, or alternatively move to the reservoir chamber.

In another aspect of the present invention, during a compression stroke, oil contained in the compression chamber may be configured to pass from the compression chamber through a compression passage to the compression solenoid valve, then through a communication hole provided in the connecting portion and interconnecting internal spaces of the first fixing portion and the second fixing portion to the rebound solenoid valve, and subsequently move to the rebound chamber or to the reservoir chamber through a second check valve configured to open only during the compression stroke and to close during the rebound stroke.

In addition, the present invention provides a vehicle including a shock absorber according to the above-described embodiment.

### Advantageous Effects of the Invention

According to the present invention, it is possible to provide a shock absorber that is easy to apply to air suspension.

In addition, according to the present invention, assemblability may be improved by reducing the number of components.

Furthermore, according to the present invention, damping force can be increased compared to conventional shock absorbers through smooth fluid flow.

However, the advantageous effects of the present invention are not limited to those described above, and other technical effects not explicitly mentioned will be clearly understood by those of ordinary skill in the art from the following description.

### BRIEF DESCRIPTION OF DRAWINGS

The accompanying drawings, which are incorporated in and constitute a part of this specification, illustrate preferred embodiments of the present invention and, together with the detailed description set forth below, serve to further clarify the technical idea of the present invention. However, the present invention should not be construed as being limited to the matters illustrated in these drawings.

FIG. 1 is a drawing for explaining a shock absorber according to one embodiment of the present invention.

FIG. 2 is a drawing for explaining a shock absorber according to another embodiment of the present invention.

FIG. 3 is a drawing for explaining the internal structure of a shock absorber according to one embodiment of the present invention.

FIG. 4 is a drawing for explaining the structure of a cylinder and a rod guide of a shock absorber according to one embodiment of the present invention.

FIG. 5 is a drawing for explaining fluid flow during a compression stroke and a rebound stroke in a shock absorber according to one embodiment of the present invention.

FIG. 6 is a longitudinal cross-sectional view of a shock absorber according to one embodiment of the present invention.

FIG. 7 is a drawing for explaining a solenoid valve of a shock absorber according to one embodiment of the present invention.

FIG. 8 is a drawing for explaining a compression solenoid valve of a shock absorber according to one embodiment of the present invention.

FIG. 9 is a drawing for explaining fluid movement during a compression stroke in a shock absorber according to one embodiment of the present invention.

FIG. 10 is a drawing for explaining fluid movement during a rebound stroke in a shock absorber according to one embodiment of the present invention.

FIG. 11 is a drawing showing an automobile including a shock absorber according to one embodiment of the present invention.

### DETAILED DESCRIPTION OF THE INVENTION

Hereinafter, embodiments of the present invention will be described in detail so that those skilled in the art to which the present invention pertains can readily carry out the invention. The present invention may be implemented in various different forms and is not limited to the embodiments described herein.

It should be noted that the drawings are schematic and not necessarily drawn to scale. The relative dimensions and proportions of parts in the drawings may be exaggerated or reduced for clarity and convenience, and any dimensions illustrated are merely exemplary and not intended to be limiting. In addition, when identical structures, elements, or parts appear in more than one drawing, the same reference numerals are used to indicate similar features.

The embodiments of the present invention specifically illustrate ideal embodiments of the present invention. As a result, various modifications of the illustrations are expected. Therefore, the embodiments are not limited to the specific shapes of the areas shown, but also include, for example, variations in shape resulting from manufacturing.

Additionally, all technical and scientific terms used in this specification, unless otherwise defined, shall have the meanings commonly understood by those skilled in the art to which the present invention pertains. All terms used in this specification have been selected for the purpose of more clearly describing the present invention and have not been selected to limit the scope of rights according to the present invention.

Additionally, expressions such as “including,” “comprising,” and “having” used in this specification should be understood as open-ended terms that imply the possibility of including other embodiments, unless otherwise stated in the phrase or sentence in which the expression is included.

Additionally, the singular expressions used herein may include plural meanings unless otherwise specified, and the same shall apply to the singular expressions used in the claims.

In addition, expressions such as ‘first’, ‘second’, etc. used in this specification are used to mutually distinguish multiple components, and do not limit the order or importance of the components.

Hereinafter, a shock absorber 1 according to a preferred embodiment of the present invention will be described in detail with reference to the accompanying drawings.

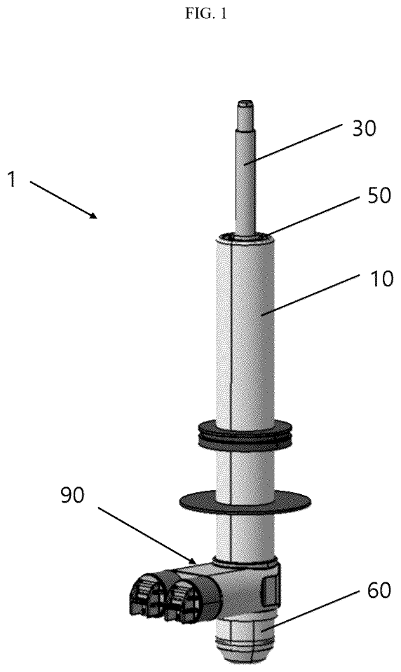

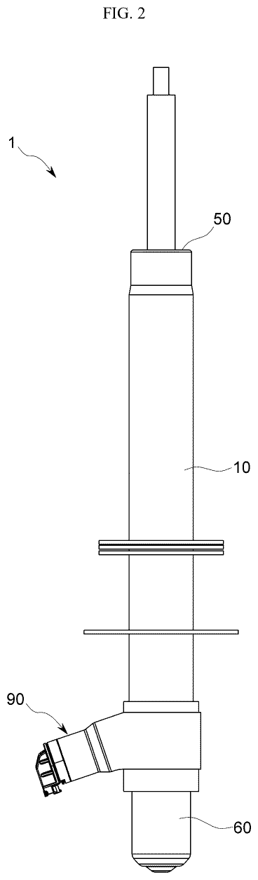

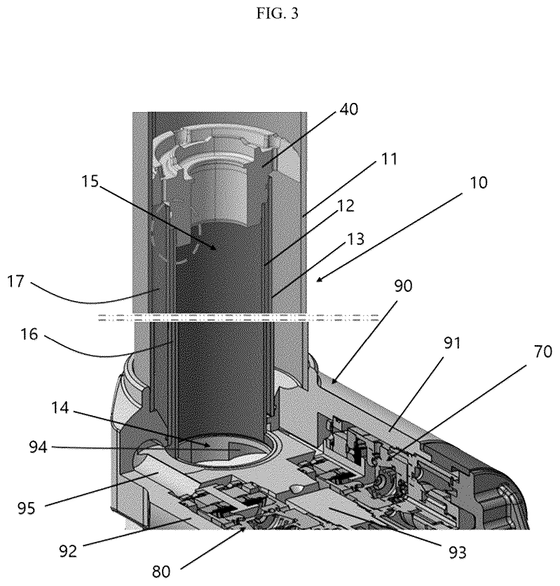

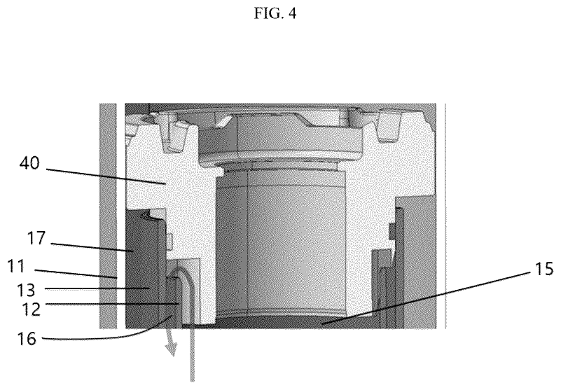

FIG. 1 is a drawing for explaining a shock absorber 1 according to one embodiment of the present invention, and FIG. 2 is a drawing for explaining a shock absorber 1 according to another embodiment of the present invention. FIG. 3 is a drawing for explaining the internal structure of a shock absorber 1 according to one embodiment of the present invention, and FIG. 4 is a drawing for explaining the structure of a cylinder 10 and a rod guide 40 of a shock absorber 1 according to one embodiment of the present invention.

Referring to FIGS. 1 and 3, a shock absorber 1 according to a preferred embodiment of the present invention includes a cylinder 10, a piston head 20, a piston rod 30, a rod guide 40, an upper cap 50, a lower cap 60, a compression solenoid valve 70, a rebound solenoid valve 80, and a post member 90.

In one aspect of the present invention, the cylinder 10 includes a base shell 11, and a first tube 12 and a second tube 13 are installed inside the base shell 11 so as to be spaced apart from each other. The above base shell 11 corresponds to the outermost case of the cylinder 10. Specifically, an internal space of the first tube 12 may be divided into a compression chamber 14 and a rebound chamber 15 by a piston head 20. In addition, the cylinder 10 may include an intermediate chamber 16 which is a space between the first tube 12 and the second tube 13 and a reservoir chamber 17 which is a space between the second tube 13 and the base shell 11.

Specifically, the cylinder 10 has a triple structure in which a first tube 12 and a second tube 13 are installed with a spacing therebetween inside a base shell 11, and a fluid is filled inside. Here, the fluid may be, for example, oil. A piston head 20 slides within the first tube 12, and an internal space of the first tube 12 is divided into a compression chamber 14 and a rebound chamber 15 by the piston head 20.

Specifically, a second tube 13 is interposed between the base shell 11 and the first tube 12. The space between the first tube 12 and the second tube 13 is referred to as an intermediate chamber 16. The intermediate chamber 16 may be configured to be in fluid communication with the rebound chamber 15. For example, at least one orifice may be provided in the upper region of the first tube 12 interposed between the intermediate chamber 16 and the rebound chamber 15. Thereby, oil can flow between the intermediate chamber 16 and the rebound chamber 15 through the orifice. Alternatively, as shown in FIGS. 3 and 4, a spacing may be provided between an end of the first tube 12 and a rod guide 40, so that the rebound chamber 15 and the intermediate chamber 16 may be configured to be in fluid communication with each other through the spacing.

Meanwhile, in the past, a structure that applied a separate tube instead of the second tube 13 was common, and as a result, there was a problem that the number of parts was large and additional parts such as ports and O-rings were inevitably required, resulting in reduced ease of assembly.

However, according to the present invention, by applying the second tube 13 in the form of a general tube instead of a separate tube, the solenoid valves 70, 80 may be directly assembled to the post member 90, thereby providing the advantage of simplifying the number of components. In addition, according to the above structure, ease of assembly can be greatly improved as components such as ports and O-rings are omitted or reduced.

In another aspect of the present invention, a space between the second tube 13 and the base shell 11 is referred to as a reservoir chamber 17. The above reservoir chamber 17 can be configured to compensate for changes in the internal volume of the compression chamber 14 and the rebound chamber 15 during the reciprocating movement of the piston head 20.

The compression chamber 14 is formed on the lower side of the cylinder 10, and the rebound chamber 15 is formed on the upper side of the cylinder 10. That is, among the internal space of the first tube 12, a region located below the piston head 20 constitutes the compression chamber 14, and among the internal space of the first tube 12, a region located above the piston head 20 constitutes the rebound chamber 15.

The piston head 20 reciprocates within the internal space of the first tube 12 to pressurize the fluid filled in the compression chamber 14 and the rebound chamber 15. In one aspect of the present invention, the piston head 20 is not provided with a bypass passage configured to allow fluid flow between the compression chamber 14 and the rebound chamber 15 during compression and rebound strokes. Accordingly, during the compression stroke, all fluid contained in the compression chamber 14 moves to the compression solenoid valve 70. Accordingly, according to the present invention, the amount of working fluid may be maximized during the compression stroke. Accordingly, according to the present invention, the damping force can be improved during the compression stroke.

For example, a separate valve may not be provided at the end of the piston head 20. That is, an end of the piston head 20 may be configured as a closed structure that prevents fluid communication. In this case, bypass of the fluid is not allowed during the compression stroke and rebound stroke, so all fluid moves through the solenoid valve 70, 80. Accordingly, the damping force of the shock absorber 1 may be effectively enhanced.

Alternatively, as another embodiment of the present invention, a structure may be applied in which fluid movement through the piston head 20 is not possible when the piston is compressed, but fluid movement through the piston head 20 is possible when the piston is tensioned. For example, during a rebound stroke, oil may move into a compression chamber of the tube through the piston head 20, or may move into an intermediate chamber 16 outside the first tube 12 through an orifice, then pass through the rebound solenoid valve 80, and subsequently move into the compression chamber of the tube through a first check valve 72 of the compression solenoid valve, or may move into a reservoir chamber 17.

According to this embodiment, since the pressure of the compression chamber is relatively lower than that of the reservoir chamber 17, the compression chamber of the tube can be normally filled, and the area of the piston rod 30 can be filled into the compression chamber 14 through the check valve of the compression solenoid connected to the reservoir chamber 17.

Referring to FIGS. 3 and 4, the piston rod 30 can be configured to slidably penetrate a rod guide 40 that closes the top of the cylinder 10. A piston head 20 is mounted at a lower end of the piston rod 30, and an upper end of the piston rod 30 is fixed to a vehicle body.

Referring to FIG. 4, the rod guide 40 shields the upper part of the cylinder 10, and a hollow guide hole is formed in the center thereof to guide the up and down movement of the piston rod 30.

Meanwhile, an upper cap 50 and a lower cap 60 are respectively mounted at upper and lower ends of the cylinder 10 to seal the upper and lower ends of the cylinder 10. The upper cap 50 can be mounted on the outer side of the upper end of the base shell 11 in a form that surrounds the upper end of the base shell 11. The lower cap 60 may be mounted on an inner side of a lower end of the base shell 11 in a form that surrounds the lower end of the base shell 11. At this time, as described above, the upper cap 50 can be positioned axially spaced apart from the first tube 12 by a predetermined distance.

Referring to FIGS. 1 and 3, the solenoid valve 70, 80 is mounted to the cylinder 10 via a post member 90. The solenoid valves 70, 80 comprise a compression solenoid valve 70 configured to variably control damping force during a compression stroke, and a rebound solenoid valve 80 configured to variably control damping force during a rebound stroke. At this time, the compression solenoid valve 70 is mounted on the cylinder 10. The above rebound solenoid valve 80 is mounted on the cylinder 10.

The post member 90 is mounted on an outer side of the cylinder 10 and is configured to support and fix the compression solenoid valve 70 and the rebound solenoid valve 80 in a spaced-apart manner. Specifically, the post member 90 may include a flange portion configured to surround the cylinder 10 on the outside of the cylinder 10. The above flange portion can be formed to extend along the axial direction of the cylinder 10. Through this, a bonding area between the post member 90 and the cylinder 10 may be increased, and sealing performance of the cylinder 10 may be enhanced.

In one aspect of the present invention, the compression solenoid valve 70 and the rebound solenoid valve 80 may be arranged along the circumferential direction of the cylinder 10. In general, since the shock absorber 1 is installed in a direction perpendicular to the ground, the compression solenoid valve 70 and the rebound solenoid valve 80 may be disposed in a horizontal direction. For example, the compression solenoid valve 70 and the rebound solenoid valve 80 can be placed on an imaginary plane perpendicular to the central axis of the cylinder 10, as shown in FIG. 1.

Alternatively, as another embodiment of the present invention, the compression solenoid valve 70 and the rebound solenoid valve 80 may be disposed on an imaginary plane forming a predetermined angle with a central axis of the cylinder 10, as illustrated in FIG. 2. For example, the angle formed by the virtual plane and the central axis of the cylinder 10 may be an acute angle or an obtuse angle. With this configuration, the space utilization of the automobile 5 can be improved.

Alternatively, as another embodiment of the present invention, the compression solenoid valve 70 and the rebound solenoid valve 80 may be disposed at positions spaced apart in the circumferential direction of the cylinder 10, while also being spaced apart in the axial direction thereof. According to this configuration, in the design of the automobile 5 body, the degree of design freedom considering the relationship with other components can be improved.

In addition, as described above, according to the structure in which the compression solenoid valve 70 and the rebound solenoid valve 80 are disposed in the circumferential direction of the cylinder 10, the assembly attains the same height as a single valve, thereby providing an advantage in that application to an air suspension is facilitated.

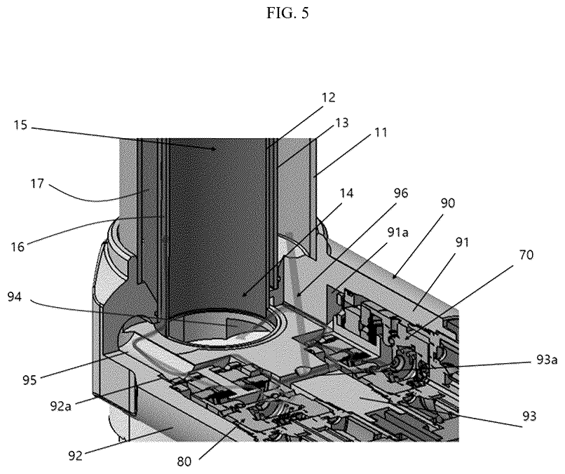

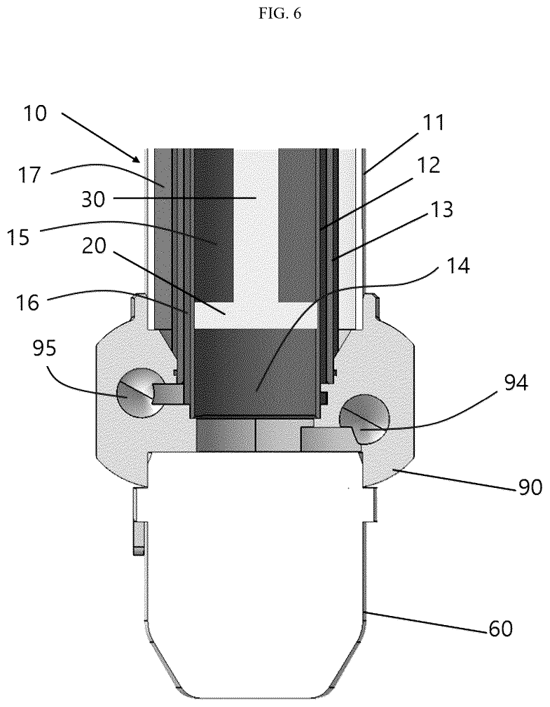

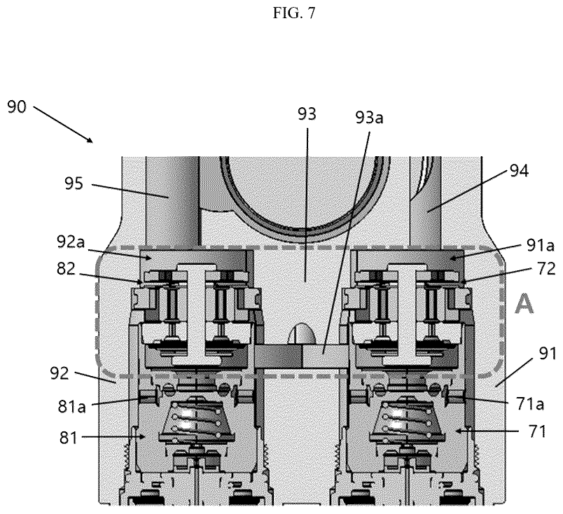

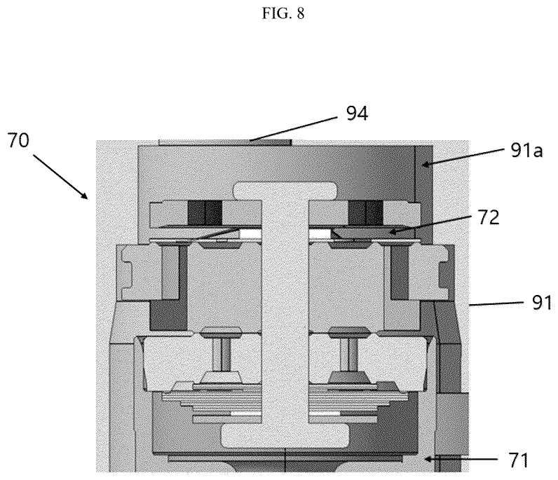

FIG. 5 is a drawing for explaining the fluid flow during the compression stroke and the rebound stroke in a shock absorber 1 according to one embodiment of the present invention, and FIG. 6 is a longitudinal cross-sectional view of a shock absorber 1 according to one embodiment of the present invention. FIG. 7 is a drawing for explaining a solenoid valve 70, 80 of a shock absorber 1 according to one embodiment of the present invention, and FIG. 8 is a drawing for explaining a compression solenoid valve 70 of a shock absorber 1 according to one embodiment of the present invention.

Here, the post member 90 will be described first, and the compression solenoid valve 70 and the rebound solenoid valve 80 and the first check valve 72 and second check valve 82 to be described later will be described later.

Referring to FIGS. 5 and 6, the post member 90 includes a first fixing portion 91, a second fixing portion 92, a connecting portion 93, a compression passage 94, a rebound passage 95, and a reservoir passage 96.

Specifically, the post member 90 includes a first hollow fixing portion 91 into which the compression solenoid valve 70 is inserted and secured, a second hollow fixing portion 92 spaced apart from the first fixing portion 91 and into which the rebound solenoid valve 80 is inserted and secured, and a connecting portion 93 that interconnects the first fixing portion 91 and the second fixing portion 92.

A first receiving bore 91a is formed in the first fixing portion 91 into which a compression solenoid valve 70 is inserted and fixed. A second receiving bore 92a is formed in the second fixing portion 92 into which a rebound solenoid valve 80 is inserted and fixed.

A communication hole 93a is formed in the connecting portion 93 so as to bring the compression solenoid valve 70 and the rebound solenoid valve 80 into direct communication by interconnecting the internal spaces of the first fixing portion 91 and the second fixing portion 92. The above communication hole 93a may be provided with a reservoir passage 96 that can directly communicate with the reservoir chamber 17. The communication hole 93a is formed parallel to the central axis of the base shell 11.

Meanwhile, the post member 90 includes a compression passage 94 configured to enable direct communication with the compression chamber 14 from one end of the first fixing portion 91. Specifically, the compression passage 94 connects one end of the first fixing portion 91 and the compression chamber 14. More specifically, the compression passage 94 connects one end of the first receiving bore 91a to the compression chamber 14, thereby allowing fluid communication therebetween.

Accordingly, the fluid can flow between the compression chamber 14 and the compression solenoid valve 70 through the compression passage 94. That is, the fluid is introduced and discharged through the compression passage 94.

The post member 90 includes a rebound passage 95 configured to enable direct communication with the intermediate chamber 16 from one end of the second fixing portion 92. Specifically, the rebound passage 95 connects the lower end of the second fixing portion 92 and the intermediate chamber 16. Accordingly, the fluid may flow between the intermediate chamber 16 and the rebound solenoid valve 80 through the rebound passage 95. Accordingly, the fluid can flow between the rebound chamber 15 configured to be in communication with the intermediate chamber 16 and the rebound solenoid valve 80. That is, the inflow and outflow of the fluid occur through the rebound passage 95.

Referring to FIGS. 7 and 8, the compression solenoid valve 70 includes a compression valve housing 71 and a first check valve 72. The compression valve housing 71 forms the exterior of the valve. The compression valve housing 71 is inserted into and fixed within the first fixing portion 91 of the post member 90. The damping force is variably controlled by adjusting the current applied to the valve as the fluid passes through the compression valve housing 71. The aforementioned compression passage 94 is provided on the inlet side of the compression valve housing 71 to enable the inflow and discharge of fluid. The first check valve 72 is installed between the compression valve housing 71 and the compression passage 94.

During the compression stroke, a portion of the fluid in the compression chamber 14 is guided toward the compression valve housing 71 through the compression passage, circulates through the compression solenoid valve 70, and is thereafter discharged to the outside of the compression valve housing 71 through the first compression hole 71a.

Specifically, a first compression hole 71a is formed on the side of the compression valve housing 71 to discharge the fluid circulating through the compression solenoid valve 70 toward the communication hole 93a. The fluid discharged through the first compression hole is transferred to the communication hole 93a of the connecting portion 93 through the space between the inner surface of the first fixing portion 91 and the compression valve housing 71 which constitute the post member 90.

During the compression stroke, the fluid introduced from the compression chamber 14 through the compression passage 94 passes between a plurality of elastic support members, then flows through the communication hole 93a and moves to the rebound chamber 15 via the second check valve 82 of the rebound solenoid valve 80, or alternatively flows to the reservoir chamber 17. During this process, the first check valve 72 is not opened but remains closed. In this case, since the pressure in the rebound chamber 15 is relatively lower than that in the reservoir chamber 17, the rebound chamber 15 of the tube is normally filled with fluid, while a volume corresponding to the area of the piston rod 30 is displaced toward the reservoir chamber 17. That is, the first check valve 72 is opened only during the rebound stroke and closed during the compression stroke.

The first check valve 72 comprises an opening and closing member configured to open and close the flow passage, and an elastic member for elastically supporting the opening and closing member. An elastic member is provided between the opening/closing member and the compression valve housing 71 in the inner space to elastically support the opening/closing member with respect to the compression valve housing 71.

During the rebound stroke, the oil may flow into the compression chamber 14 through the piston, or the oil contained in the rebound chamber 15 may move from the rebound chamber 15 to the intermediate chamber 16 through the orifice, then pass through the rebound passage 95 and the rebound solenoid valve 80, and subsequently flow through the communication hole 93a to the compression chamber 14 or to the reservoir chamber 17 via the first check valve 72 of the compression solenoid valve 70, 80. In this case, since the pressure in the compression chamber 14 is relatively lower than that in the reservoir chamber 17, the compression chamber 14 of the tube may be normally filled with fluid, and a volume corresponding to the area of the piston rod 30 may be supplied to the compression chamber 14 through the first check valve 72 of the compression solenoid valve 70 that is in communication with the reservoir chamber 17.

Referring to FIG. 7, the rebound solenoid valve 80 includes a rebound valve housing 81 and a second check valve 82. The rebound valve housing 81 forms the exterior of the valve. The rebound valve housing 81 is inserted and fixed into the second fixing portion 92 of the post member 90. The damping force is variably controlled by adjusting the current applied to the valve while the fluid flows through the rebound valve housing 81. The aforementioned rebound passage 95 is provided on the inlet side of the rebound valve housing 81 to enable the inflow and discharge of fluid. The second check valve 82 is installed between the rebound valve housing 81 and the rebound passage 95.

During the rebound stroke, a portion of the fluid in the rebound chamber 15 flows through the intermediate chamber 16 and the rebound passage 95 into the internal space of the second fixing portion 92, is then guided toward the rebound valve housing 81, circulates through the rebound solenoid valve 80, and is subsequently discharged.

A plurality of first rebound holes 81a are formed on the side of the rebound valve housing 81 to discharge fluid passing through the rebound solenoid valve 80. The fluid discharged through the first rebound hole 81a is transferred to the communication hole 93a of the connecting portion 93 through the space between the inner surface of the second fixing portion 92 and the rebound valve housing 81 which constitute the post member 90.

During the rebound stroke, the fluid introduced from the rebound chamber 15 through the rebound passage 95 passes between a plurality of elastic support members, then flows through the communication hole 93a and moves to the compression chamber 14 via the first check valve 72 of the compression solenoid valve 70, or alternatively flows to the reservoir chamber 17. During this process, the second check valve 82 is not opened but remains closed. In this case, since the pressure in the compression chamber 14 is relatively lower than that in the reservoir chamber 17, the compression chamber 14 of the tube may be normally filled with fluid, and a volume corresponding to the area of the piston rod 30 is displaced toward the reservoir chamber 17. That is, the second check valve 82 is opened only during the compression stroke and closed during the rebound stroke.

The second check valve 82 comprises an opening and closing member configured to open and close the flow passage, and an elastic member configured to elastically support the opening and closing member. An elastic member is provided between the opening/closing member and the rebound valve housing 81 in the inner space to elastically support the opening/closing member with respect to the rebound valve housing 81.

During the compression stroke, the oil accommodated in the compression chamber 14 flows from the compression chamber 14 through the compression passage 94, passes through the compression solenoid valve 70, and then moves to the rebound chamber 15 via the second check valve 82 of the rebound solenoid valve 80, or alternatively flows to the reservoir chamber 17.

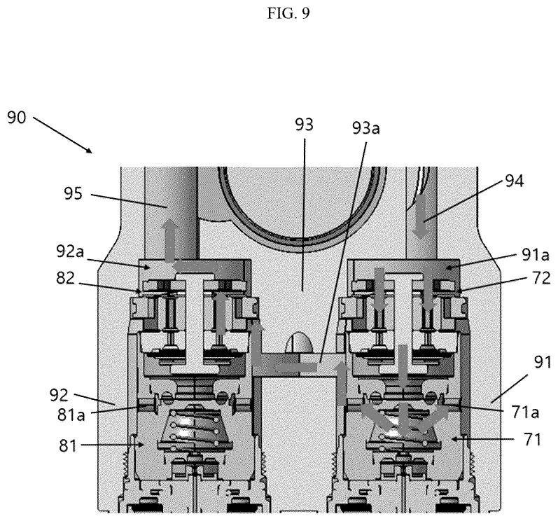

FIG. 9 is a drawing for explaining fluid movement during a compression stroke in a shock absorber 1 according to one embodiment of the present invention.

Referring to FIG. 9, as shown, the fluid inside the compression chamber 14 is compressed during the downward stroke of the piston head 20, i.e., the compression stroke. Accordingly, the interior of the compression chamber 14 is brought into a high-pressure state, while the interior of the rebound chamber 15 is brought into a low-pressure state.

As the piston head 20 descends, all fluid within the compression chamber 14 is guided to the compression solenoid valve 70 through the compression path and circulates inside the compression solenoid valve 70. During the process of fluid circulating within the compression solenoid valve 70, the damping force is variably controlled by varying the current applied to the compression solenoid valve 70.

The fluid that has passed through the compression solenoid valve 70 flows through the first compression hole 71a of the compression valve housing 71 and moves to the communication hole 93a of the connecting portion 93. The fluid in the communication hole 93a can move to the reservoir chamber 17 through the reservoir passage 96 connected to the communication hole 93a. Alternatively, the fluid in the communication hole 93a can be guided to the second receiving bore 92a, which is the internal space of the second fixing portion 92 connected to the communication hole 93a. The fluid that has moved into the second receiving bore 92a may flow into the intermediate chamber 16 through the rebound passage 95 connected to the second receiving bore 92a. The fluid that has moved to the intermediate chamber 16 moves to the rebound chamber 15 connected to the intermediate chamber 16 through an orifice.

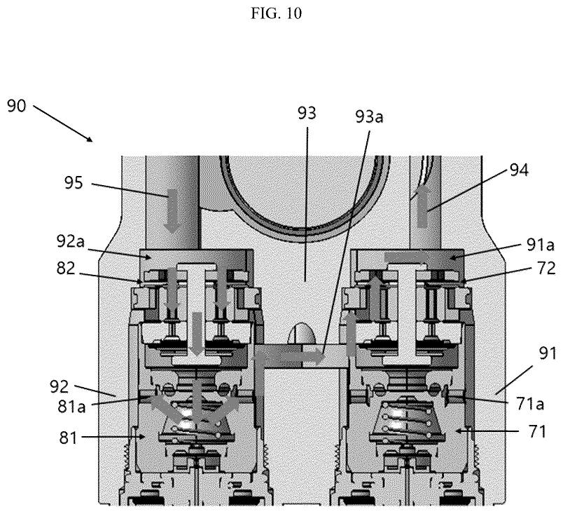

FIG. 10 is a drawing for explaining fluid movement during a rebound stroke in a shock absorber 1 according to one embodiment of the present invention.

Referring to FIG. 10, as shown, the fluid in the rebound chamber 15 is compressed during the stroke in which the piston head 20 rises, i.e., the rebound stroke. Accordingly, the interior of the rebound chamber 15 is brought into a high-pressure state, while the interior of the compression chamber 14 is brought into a low-pressure state.

As the piston head 20 moves upward, a portion of the fluid in the rebound chamber 15 is transferred to the intermediate chamber 16 through an orifice or a gap formed on the upper side of the first tube 12, and is then guided to the rebound solenoid valve 80 through the rebound passage 95, where it circulates through the rebound solenoid valve 80. The damping force is variably controlled by varying the current applied to the rebound solenoid valve 80 during the process of fluid circulating within the rebound solenoid valve 80.

The fluid that has passed through the rebound solenoid valve 80 flows through the first rebound hole 81a of the rebound valve housing 81 and moves to the communication hole 93a of the connecting portion 93. The fluid in the communication hole 93a can move to the reservoir chamber 17 through the reservoir passage 96 connected to the communication hole 93a. Alternatively, the fluid in the communication hole 93a can be guided to the first receiving bore 91a, which is the internal space of the first fixing portion 91 connected to the communication hole 93a. The fluid that has moved to the first receiving bore 91a moves to the compression chamber 14 through the compression passage 94 connected to the first receiving bore 91a.

As described above, by adopting a structure in which check valves are applied to the compression solenoid valve 70 and the rebound solenoid valve 80, smooth fluid flow within the damper can be achieved. In addition, according to the above-described structure, the damping force on the compression side can be effectively enhanced compared with that of a conventional twin or mono type.

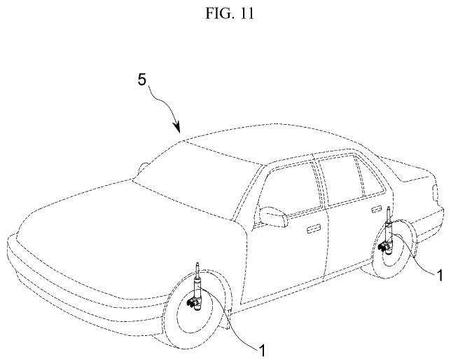

FIG. 11 is a drawing showing an automobile including a shock absorber 1 according to one embodiment of the present invention.

Meanwhile, the automobile 5 according to the present invention may include a shock absorber 1 according to the present invention. At this time, the shock absorber 1 can connect each wheel of the vehicle 5 and the vehicle body.

That is, the shock absorber 1 according to the present invention can be applied to an automobile 5, such as an internal combustion engine automobile, an electric automobile 5, or a hybrid automobile 5. In addition, a vehicle 5 according to the present invention may further include various other components included in the vehicle 5 in addition to the shock absorber 1.

As described above, the shock absorber 1 according to a preferred embodiment of the present invention has been described in detail with reference to the accompanying drawings; however, the present invention is not limited to the foregoing embodiment and may be variously modified and implemented within the scope of the claims.

The above description is merely illustrative of the technical concept of the present invention, and it will be apparent to those skilled in the art that various modifications, alterations, and substitutions may be made without departing from the essential spirit and scope of the present invention. Therefore, the embodiments are for illustrative purposes and not for limiting the technical spirit of the present invention, and the scope of the technical spirit of the present invention is not limited by these embodiments. The scope of protection of the present invention shall be interpreted based on the following claims, and all technical ideas falling within an equivalent scope shall be construed as being included within the scope of the present invention.

### Reference Numerals

1: Shock Absorber
10: Cylinder
11: Base Shell
12: First Tube
13: Second Tube
14: Compression Chamber
15: Rebound Chamber
16: Intermediate Chamber
17: Reservoir Chamber
20: Piston Head
30: Piston Rod
40: Rod Guide
50: Upper Cap
60: Lower Cap
70: Compression Solenoid Valve
71: Compression Valve Housing
72: First Check Valve
80: Rebound Solenoid Valve
81: Rebound Valve Housing
82: Second Check Valve
90: Post Member
91: First Fixing Portion
92: Second Fixing Portion
93: Connecting Portion
94: Compression Passage
95: Rebound Passage
96: Reservoir Passage
91a: First Receiving Bore
92a: Second Receiving Bore
93a: Communication Hole

1. A shock absorber, comprising: a cylinder which includes a base shell, and a first tube and a second tube installed so as to be spaced apart inside the base shell, wherein an internal space of the first tube is divided into a compression chamber and a rebound chamber by a piston head, and the cylinder includes an intermediate chamber, which is a space between the first tube and the second tube, and a reservoir chamber, which is a space between the second tube and the base shell;
a compression solenoid valve mounted on the cylinder; and
a rebound solenoid valve mounted on the cylinder, wherein
the compression solenoid valve and the rebound solenoid valve are arranged along a circumferential direction of the cylinder.

2. The shock absorber of claim 1, wherein
the compression solenoid valve and the rebound solenoid valve are arranged in a horizontal direction.

3. The shock absorber of claim 1, wherein
the compression solenoid valve and the rebound solenoid valve are arranged on an imaginary plane perpendicular to a central axis of the cylinder.

4. The shock absorber of claim 1, wherein
the compression solenoid valve and the rebound solenoid valve are arranged on an imaginary plane forming a predetermined angle with a central axis of the cylinder, and the predetermined angle is configured as an acute angle or an obtuse angle.

5. The shock absorber of claim 1, further comprising:
a post member mounted on the outside of the cylinder and configured to fixedly support the compression solenoid valve and the rebound solenoid valve so they are spaced apart.

6. The shock absorber of claim 5, wherein
the post member comprises:
a first hollow fixing portion into which the compression solenoid valve is inserted and fixed;
a second hollow fixing portion spaced apart from the first fixing portion and into which the rebound solenoid valve is inserted and fixed; and
a connecting portion connecting the first fixing portion and
the second fixing portion.

7. The shock absorber of claim 6, wherein:
a first receiving bore, into which the compression solenoid valve is inserted and fixed, is formed in the first fixing portion, and
a second receiving bore, into which the rebound solenoid valve is inserted and fixed, is formed in the second fixing portion.

8. The shock absorber of claim 6, wherein
a communication hole is formed in the connecting portion to directly bring the compression solenoid valve and the rebound solenoid valve into communication by interconnecting the internal spaces of the first fixing portion and the second fixing portion.

9. The shock absorber of claim 8, wherein
the communication hole is provided with a reservoir passage in direct communication with the reservoir chamber.

10. The shock absorber of claim 7, wherein
the post member comprises:
a compression passage configured to be in direct communication with the compression chamber from one end of the first fixing portion.

11. The shock absorber of claim 10, wherein
the compression passage connects one end of the first receiving bore and the compression chamber.

12. The shock absorber of claim 10, wherein
the post member comprises:
a rebound passage configured to be in direct communication with the intermediate chamber from one end of the second fixing portion.

13. The shock absorber of claim 12, wherein
the rebound passage connects one end of the second receiving bore and the intermediate chamber.

14. The shock absorber of claim 1, wherein
the intermediate chamber is configured to be in communication with the rebound chamber.

15. The shock absorber of claim 1, wherein
at least one orifice is provided in an upper region of the first tube interposed between the intermediate chamber and the rebound chamber, and oil is configured to flow between the intermediate chamber and the rebound chamber through the orifice.

16. The shock absorber of claim 12, wherein
the compression solenoid valve comprises:
a compression valve housing forming the exterior of the valve; and
a first check valve configured to open only during a rebound stroke and be closed during a compression stroke.

17. The shock absorber of claim 1, wherein
the rebound solenoid valve comprises:
a rebound valve housing forming the exterior of the valve; and
a second check valve configured to open only during a compression stroke and be closed during a rebound stroke.

18. The shock absorber of claim 16, wherein:
during a rebound stroke,
oil accommodated in the rebound chamber is configured to move from the rebound chamber to the intermediate chamber through an orifice provided in an upper region of the first tube interposed between the intermediate chamber and the rebound chamber, then pass through the rebound passage and the rebound solenoid valve, and then move to the compression chamber through the first check valve of the compression solenoid valve via a communication hole provided in the connecting portion and communicating the internal spaces of the first fixing portion and the second fixing portion, or
move to the reservoir chamber.

19. The shock absorber of claim 16, wherein:
during a compression stroke,
oil accommodated in the compression chamber is configured to pass from the compression chamber through the compression passage and the compression solenoid valve, and then move to the rebound chamber through a second check valve, which is provided in the rebound solenoid valve and is configured to open only during the compression stroke and be closed during the rebound stroke, via a communication hole provided in the connecting portion and communicating the internal spaces of the first fixing portion and the second fixing portion, or
move to the reservoir chamber.

20. A vehicle comprising the shock absorber as described in claim 1.
